(19) United States
(12) Patent Application Publication
(10) Pub. No.: US 2023/0304921 A1
(43) Pub. Date: Sep. 28, 2023

(54) INFRARED MEASUREMENT METHOD AND APPARATUS, COMPUTER DEVICE AND STORAGE MEDIUM

(71) Applicant: Nankai University, Tianjin (CN)

(72) Inventors: MENG-XIN REN, Tianjin (CN); WEI WU, Tianjin (CN); ZHANG-HANG ZHU, Tianjin (CN); DI ZHANG, Tianjin (CN); WEI CAI, Tianjin (CN); JING-JUN XU, Tianjin (CN)

(21) Appl. No.: 17/966,894

(22) Filed: Oct. 17, 2022

(30) Foreign Application Priority Data
Mar. 22, 2022 (CN) 202210282813.9

(51) Int. Cl. G01N 21/21; G01J 4/04; G01J 3/447

(52) U.S. Cl. CPC G01N 21/211; G01J 4/04; G01J 3/447; G01N 2021/213

(57) ABSTRACT

The disclosure relates to an infrared measurement method and apparatus, a computer device, a storage medium, and a computer program product. The method includes: detecting intensity information of sum-frequency mixing light projected on different polarization bases in a to-be-measured scene, the sum-frequency mixing light is generated in a sum-frequency mixing process of infrared signal light and pump light; determining polarization information of the sum-frequency mixing light according to the intensity information of the sum-frequency mixing light projected on the different polarization bases; determining polarization information of the infrared signal light according to the polarization information of the sum-frequency mixing light and a Mueller matrix, the Mueller matrix is constructed based on a second-order nonlinear polarizability corresponding to a sum-frequency mixing device and the polarization information of the pump light; determining detection information of a to-be-measured target in the to-be-measured scene according to the polarization information of the infrared signal light.

### CROSS REFERENCE TO RELATED APPLICATION

The present application claims priority to China Patent Application with No. 202210282813.9, entitled “Infrared Measurement Method and Apparatus, Computer Device and Storage Medium”, and filed on Mar. 22, 2022, the content of which is expressly incorporated herein by reference in its entirety.

### TECHNICAL FIELD

The present disclosure relates to the field of measurement technology, and particularly to an infrared measurement method and apparatus, a computer device and a storage medium.

### BACKGROUND

With the development of measurement technology, the infrared measurement technology has emerged, which can realize the long-distance, multi-target, non-contact and night-time measurements.

In the conventional infrared measurement technology, the geometric structure of a to-be-measured target is measured by acquiring the intensity of the infrared signal light scattered, reflected or projected by the to-be measured target. However, the current infrared measurement technology is easily limited by the cluttered background signals, and accordingly the detection accuracy of the to-be-measured target is lower.

### SUMMARY

In view of this, it is necessary to provide an infrared measurement method and apparatus, a computer device, a computer-readable storage medium, and a computer program product that are not easily affected by background signals and can measure the to-be-measured target with a high precision.

In the first aspect, the present disclosure provides an infrared measurement method, including:
detecting intensity information of sum-frequency mixing light projected on different polarization bases in a to-be-measured scene, wherein the sum-frequency mixing light is generated in a sum-frequency mixing process of infrared signal light and pump light;
determining polarization information of the sum-frequency mixing light according to the intensity information of the sum-frequency mixing light projected on the different polarization bases;
determining polarization information of the infrared signal light according to the polarization information of the sum-frequency mixing light and a Mueller matrix, wherein the Mueller matrix is constructed based on a second-order nonlinear polarizability corresponding to a sum-frequency mixing device and the polarization information of the pump light;
determining detection information of a to-be-measured target in the to-be-measured scene according to the polarization information of the infrared signal light.

In an embodiment, the polarization information of the sum-frequency mixing light is a Stokes vector of the sum-frequency mixing light, and the determining polarization information of the infrared signal light according to the polarization information of the sum-frequency mixing light and the Mueller matrix includes:
multiplying the Stokes vector of the sum-frequency mixing light by an inverse matrix of the Mueller matrix to obtain a Stokes vector of the infrared signal light.

In an embodiment, the method further includes:
collecting first polarization information of infrared signal light under a preset number of polarization states and second polarization information of a target sum-frequency mixing light corresponding to the infrared signal light under the preset number of polarization states in a preset calibration environment;
determining the Mueller matrix according to the first polarization information and the second polarization information.

In an embodiment, the determining the Mueller matrix according to the first polarization information and the second polarization information includes:
constructing an expression of the Mueller matrix according to the second-order nonlinear polarizability and the polarization information of the pump light;
determining the Mueller matrix according to the first polarization information, the second polarization information, the expression, and a least square method.

In an embodiment, the method further includes:
detecting intensity information of the pump light projected on different polarization bases in the to-be-measured scene;
determining polarization information of the pump light according to the intensity information of the pump light projected on the different polarization bases;
determining the Mueller matrix according to the polarization information of the pump light and the preset second-order nonlinear polarizability.

In the second aspect, the present disclosure further provides an infrared measurement device, including:
a light source configured to generate infrared signal light and pump light;
a sum-frequency mixing device configured to perform a sum-frequency mixing process on the infrared signal light and the pump light in a to-be-measured scene to generate sum-frequency mixing light;
a polarization state analyzer configured to acquire the sum-frequency mixing light projected on different polarization bases;
a visible-light detector configured to detect intensity information of the sum-frequency mixing light projected on the different polarization bases;
a processor configured to: determine polarization information of the sum-frequency mixing light according to the intensity information of the sum-frequency mixing light projected on different polarization bases; obtain polarization information of the infrared signal light according to the polarization information of the sum-frequency mixing light and a Mueller matrix, wherein the Mueller matrix is constructed based on a second-order nonlinear polarizability corresponding to the sum-frequency mixing device and polarization information of the pump light; and determine detection information of a to-be-measured target in the to-be-measured scene according to the polarization information of the infrared signal light.

In the third aspect, the present disclosure further provides an infrared measurement apparatus, including:
a detection module, configured to detect intensity information of sum-frequency mixing light projected on different polarization bases in a to-be-measured scene, wherein the sum-frequency mixing light is generated in a sum-frequency mixing process of infrared signal light and pump light;
a first determination module, configured to determine polarization information of the sum-frequency mixing light according to the intensity information of the sum-frequency mixing light projected on the different polarization bases;
a second determination module, configured to determine polarization information of the infrared signal light according to the polarization information of the sum-frequency mixing light and a Mueller matrix, wherein the Mueller matrix is constructed based on a second-order nonlinear polarizability corresponding to a sum-frequency mixing device and polarization information of the pump light;
a third determination module, configured to determine detection information of a to-be-measured target in the to-be-measured scene according to the polarization information of the infrared signal light.

In an embodiment, the second determination module is configured to:
multiple the Stokes vector of the sum-frequency mixing light by an inverse matrix of the Mueller matrix to obtain a Stokes vector of the infrared signal light.

In an embodiment, the infrared measurement apparatus further includes:
a calibration module, configured to collect first polarization information of infrared signal light under a preset number of polarization states and second polarization information of a target sum-frequency mixing light corresponding to the infrared signal light under the preset number of polarization states in a preset calibration environment; in which the target sum-frequency mixing light is sum-frequency mixing light generated in the sum-frequency mixing process of the infrared signal light under the preset number of polarization states and the pump light;
a fourth determination module, configured to determine the Mueller matrix according to the first polarization information and the second polarization information.

In an embodiment, the fourth determination module is configured to:
construct the expression of the Mueller matrix according to the second-order nonlinear polarizability and the polarization information of the pump light, and determine the Mueller matrix according to the first polarization information, the second polarization information, the expression and the least square method.

In an embodiment, the infrared measurement apparatus further includes:
a pump light detection module, configured to detect intensity information of the pump light projected on different polarization bases in the to-be-measured scene;
a fifth determination module, configured to determine polarization information of the pump light according to the intensity information of the pump light projected on different polarization bases;
a sixth determination module, configured to determine the Mueller matrix according to the polarization information of the pump light and the preset second-order nonlinear polarizability.

In the fourth aspect, the present disclosure further provides a computer device, including a processor and a memory for storing a computer program, when executing the computer program, the processor implements the method in the first aspect.

In the fifth aspect, the present disclosure further provides a computer-readable storage medium, on which a computer program is stored, when the computer program is executed by a processor, the method in the first aspect is implemented.

In the sixth aspect, the present disclosure further provides a computer program product, including a computer program, the method in the first aspect is implemented when the computer program is executed by a processor.

In the above-mentioned infrared measurement method and apparatus, computer device and storage medium, intensity information of sum-frequency mixing light projected on different polarization bases in a to-be-measured scene is detected, in which the sum-frequency mixing light is generated in a sum-frequency mixing process of infrared signal light and pump light; polarization information of the sum-frequency mixing light is determined according to the intensity information of the sum-frequency mixing light projected on the different polarization bases; polarization information of the infrared signal light is determined according to the polarization information of the sum-frequency mixing light and a Mueller matrix, in which the Mueller matrix is constructed based on a second-order nonlinear polarizability corresponding to a sum-frequency mixing device and the polarization information of the pump light; detection information of a to-be-measured target in the to-be-measured scene is determined according to the polarization information of the infrared signal light. Since the detection accuracy of the sum-frequency mixing light is higher than that of the infrared signal light, the polarization information of the infrared signal light with a higher accuracy can be obtained by inversing the polarization information of the sum-frequency mixing light, and then the to-be-measured target is detected by means of the polarization information of the infrared signal light, accordingly, the detection accuracy of the to-be-measured target can be effectively improved.

### BRIEF DESCRIPTION OF THE DRAWINGS

FIG. 1 is an application environment diagram of an infrared measurement device according to an embodiment of the present disclosure.

FIG. 2 is a flow chart showing an infrared measurement method according to an embodiment of the present disclosure.

FIG. 3 is a schematic calculation diagram of a formula (2) according to an embodiment of the present disclosure.

FIG. 4 is a flow chart an infrared measurement method calibrating a Mueller matrix according to an embodiment of the present disclosure.

FIG. 5 is a schematic structure diagram of an infrared measurement device according to an embodiment of the present disclosure.

FIG. 6a is a Poincare sphere diagram of infrared signal light measured by an infrared measurement method according to an embodiment of the resent disclosure.

FIG. 6b is a Poincare sphere diagram of sum-frequency mixing light measured by an infrared measurement method according to an embodiment of the resent disclosure.

FIG. 6c is a two-dimensional plan view of an expanded Poincare sphere diagram of infrared signal light measured by an infrared measurement method according to an embodiment of the resent disclosure.

FIG. 6d is a two-dimensional plan view of an expanded Poincare sphere diagram of sum-frequency mixing light measured by an infrared measurement method according to an embodiment of the resent disclosure.

FIGS. 7a, 7b and 7c are respectively polarization imaging comparison diagrams of L and N-shaped masks measured by an infrared measurement method according to embodiments of the resent disclosure.

FIGS. 8a, 8b and 8c are respectively polarization imaging comparison diagrams of a house-shaped mask measured by an infrared measurement method according to embodiments of the resent disclosure.

FIGS. 9a, 9b and 9c are respectively polarized imaging comparison diagrams of a plastic ruler measured by an infrared measurement method according to embodiments of the resent disclosure.

FIG. 10 is an intensity image of a plastic ruler measured by an infrared measurement method according to an embodiment of the resent disclosure.

FIG. 11 is a structure block diagram illustrating an infrared measurement apparatus according to an embodiment of the resent disclosure.

FIG. 12 is an internal structure diagram of a computer device according to an embodiment of the resent disclosure.

### DETAILED DESCRIPTION

In order to make the purpose, technical solution and advantages of the present disclosure clearer, the present disclosure will be described in further detail below with reference to the accompanying drawings and embodiments. It should be appreciated that the specific embodiments described herein are merely utilized to explain the present disclosure, but not to limit the present disclosure.

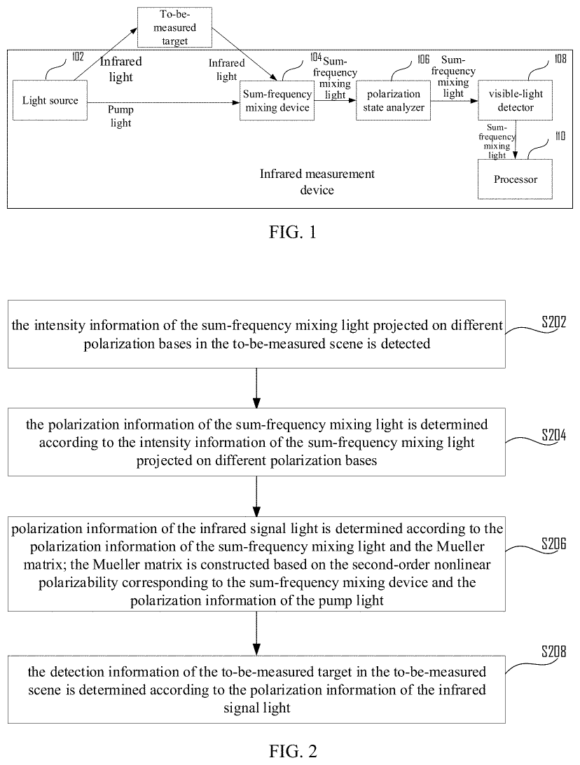

The infrared measurement method provided by the embodiment of the present disclosure can be applied to a terminal, and the terminal may be a terminal which implements an infrared measurement function by detecting the sum-frequency mixing light and obtaining the infrared signal light through the inversion, such as an infrared measurement device. As shown in FIG. 1, it is an application environment diagram of an infrared measurement device provided by an embodiment of the present disclosure, in which the infrared measurement device includes a light source 102, a sum-frequency mixing device 104, a Polarization State Analyzer (PSA) 106, a visible-light detector 108, and a processor 110. Optionally, the light source may include a laser oscillator and a beam splitter, or two laser oscillators. It can be appreciated that any light source capable of generating the infrared signal light and pump light can be applied to the embodiment of the present disclosure, which is not limited in the embodiment of the present disclosure.

The light source 102 is configured to generate the infrared signal light and pump light. The infrared signal light is outputted to the to-be-measured target, and is scattered, reflected or transmitted by the to-be-measured target, and then the infrared signal light carries information of the target. Sum-frequency mixing of the infrared signal light scattered, reflected or projected by the to-be-measured target and the pump light is performed on the sum-frequency mixing device 104, and sum-frequency mixing light is generated. The pump light has the sum-frequency mixing process with the infrared signal light under a medium nonlinear interaction. The sum-frequency mixing process can generate the sum-frequency mixing light. A wavelength of the sum-frequency mixing light is in the visible range. The pump light can be, but is not limited to, the infrared light or visible light.

The sum-frequency mixing light is incident to the polarization state analyzer 106, and then the polarization state analyzer 106 outputs the sum-frequency mixing light projected on different polarization bases. The visible-light detector 108 is configured to detect intensity information of the sum-frequency mixing light projected on different polarization bases, and transmit intensity information of the detected sum-frequency mixing light projected on different polarization bases to the processor 110. The terminal can determine the polarization information of the sum-frequency mixing light through the processor 110 according to the intensity information of the sum-frequency mixing light projected on different polarization bases, and obtain polarization information of the infrared signal light according to the polarization information of the sum-frequency mixing light and the preset Mueller matrix. The Mueller matrix is constructed based on a second-order nonlinear polarizability corresponding to the sum-frequency mixing device and the polarization information of the pump light. In such a manner, the terminal can determine the detection information of the to-be-measured target in the to-be-measured scene according to the polarization information of the infrared signal light. Optionally, the infrared measurement device may further include other components such as a polarization state modulator, a lens, and a mechanical delay line, etc., which are not limited in this embodiment of the present disclosure.

In an embodiment, as shown in FIG. 2, an infrared measurement method is provided, which is applied to the terminal in FIG. 1 as an example for description, and the method includes the following steps.

Step 202: the intensity information of the sum-frequency mixing light projected on different polarization bases in the to-be-measured scene is detected.

The sum-frequency mixing light is generated in the sum-frequency mixing process of the infrared signal light and the pump light, and the wavelength of the sum-frequency mixing light is in the visible range.

In the embodiment of the present disclosure, in the to-be-measured scene, the terminal may generate the infrared signal light and the pump light through the light source 102. The infrared signal light irradiates the to-be-measured target, so that the infrared signal light carries the detection information of the to-be-measured target. The infrared signal light scattered, reflected or projected by the to-be-measured target and the pump light are condensed and imaged through a lens group onto the sum-frequency mixing device 104 to perform the sum-frequency mixing and generate the sum-frequency mixing light. Alternatively, the light source 102 may include a laser oscillator and a beam splitter; the sum-frequency mixing device 104 may be a lithium niobate (LN) thin film. The lens group may include two or more lenses, which condense and image the infrared signal light scattered, reflected or projected by the to-be-measured target and the pump light onto the sum-frequency mixing device 104.

The sum-frequency mixing light is incident to the polarization state analyzer 106, and then the polarization state analyzer 106 outputs the sum-frequency mixing light projected on different polarization bases. The terminal can detect the intensity information of the sum-frequency mixing light projected on different polarization bases through the visible-light detector 108. Optionally, the polarization state analyzer 106 may include a waveplate and a polarizer; the waveplate may be a first rotatable quarter-wave plate (QWP), and the polarizer may be a first Glan-Taylor prism. The visible-light detector 108 may be a charge-coupled device (CCD), an electron-multiplying charge-coupled device (EMCCD), etc.

Step 204: the polarization information of the sum-frequency mixing light is determined according to the intensity information of the sum-frequency mixing light projected on different polarization bases.

The polarization information of the sum-frequency mixing light can be a Stokes vector of the sum-frequency mixing light.

In the embodiment of the present disclosure, the visible-light detector 108 is configured to transmit the intensity information of the sum-frequency mixing light projected on different polarization bases to the processor 110. The processor 110 processes the intensity information of the sum-frequency mixing light projected on different polarization bases to obtain the Stokes vector of the sum-frequency mixing light. Optionally, any algorithm by which the polarization information can be obtained from the intensity information and an algorithm for identifying the polarization information of the to-be-measured target from an intensity image can be applied to the embodiment of the present disclosure, which is not limited by the embodiments of the present disclosure.

Step 206: polarization information of the infrared signal light is determined according to the polarization information of the sum-frequency mixing light and the Mueller matrix.

The Mueller matrix is constructed based on the second-order nonlinear polarizability corresponding to the sum-frequency mixing device and the polarization information of the pump light. The second-order nonlinear polarizability is a second-order nonlinear polarizability of the sum-frequency mixing device 104. The polarization information of the infrared signal light is a Stokes vector of the infrared signal light.

In the embodiment of the present disclosure, the expression of the Mueller matrix is shown as the following formula (1):

$$M ( {χ}^{( 2 )} , {S}^{{ω}_{2}} ) = [ \begin{matrix}{m}_{11} & {m}_{12} & {m}_{13} & {m}_{14} \\ {m}_{21} & {m}_{22} & {m}_{23} & {m}_{24} \\ {m}_{31} & {m}_{32} & {m}_{33} & {m}_{34} \\ {m}_{41} & {m}_{42} & {m}_{43} & {m}_{44}\end{matrix} ] \qquad ( 1 )$$

Where M(χ⁽²⁾, S^{ω}^{₂}) is the Mueller matrix; χ⁽²⁾ is the second-order nonlinear polarizability; S^{ω}^{₂} is the Stokes vector of the pump light; mₗₙ(l, n=1˜4) is an element in the l-th row and n-th column of the Mueller matrix.

It can be understood that after obtaining the Stokes vector of the sum-frequency mixing light, the processor 110 calculates and obtains the Stokes vector of the infrared signal light according to the Stokes vector of the sum-frequency mixing light and the preset Mueller matrix.

Step 208: the detection information of the to-be-measured target in the to-be-measured scene is determined according to the polarization information of the infrared signal light.

The detection information of the to-be-measured target in the to-be-measured scene includes a geometric structure, an internal birefringence, an internal stress, a surface roughness degree, and a surface texture of the to-be-measured target in the to-be-measured scene, etc.

In the embodiment of the present disclosure, the processor 110 synthesizes a polarization image of the to-be-measured target in the to-be-measured scene according to the Stokes vector of the infrared signal light. After that, the processor 110 performs a target detection on the polarization image to obtain the detection information of the to-be-measured target in the to-be-measured scene. Optionally, any algorithm by which the polarization image can be obtained through the inversion from the polarization information and an algorithm for identifying the to-be-measured target from the polarization image can be applied to the embodiments of the present disclosure, which are not limited in the embodiments of the present disclosure.

In the above infrared measurement method, the polarization information of the sum-frequency mixing light can be obtained by detecting the intensity information of the sum-frequency mixing light projected on different polarization bases, and then obtaining the polarization information of the infrared signal light through the inversion from the polarization information of the sum-frequency mixing light, to indirectly acquire the polarization information of the infrared signal light. Since the detection accuracy of the sum-frequency mixing light is higher than that of the infrared signal light, the polarization information of the infrared signal light with a higher accuracy can be obtained through the inversion based on the polarization information of the sum-frequency mixing light. Accordingly, the to-be-measured target is detected according to the polarization information, which can effectively improve the detection accuracy of the to-be-measured target. In addition, the visible-light detector has a small volume, a high sensitivity, a high pixel density and a mature technology, so that the to-be-measured target can be detected more efficiently with the infrared measurement method in the present disclosure.

In an embodiment, step 206 includes:

the Stokes vector of the sum-frequency mixing light is multiplied by an inverse matrix of the Mueller matrix to obtain the Stokes vector of the infrared signal light.

In the embodiment of the present disclosure, the processor 110 inputs the Stokes vector of the sum-frequency mixing light into the following formula (2) to obtain the Stokes vector of the infrared signal light:

S^{ω}^{₁}=M⁻¹(χ⁽²⁾,S^{ω}^{₂})·S^{ω}^{₃}, (2)

where S^{ω}^{₁} is the Stokes vector of the infrared signal light; χ⁽²⁾ is the second-order nonlinear polarizability; S^{ω}^{₂} is the Stokes vector of the pump light; M(χ⁽²⁾, S^{ω}^{₂}) is the Mueller matrix; M⁻¹(χ⁽²⁾, S^{ω}^{₂}) is the inverse matrix of the Mueller matrix; and S^{ω}^{₃} is the Stokes vector of the sum-frequency mixing light.

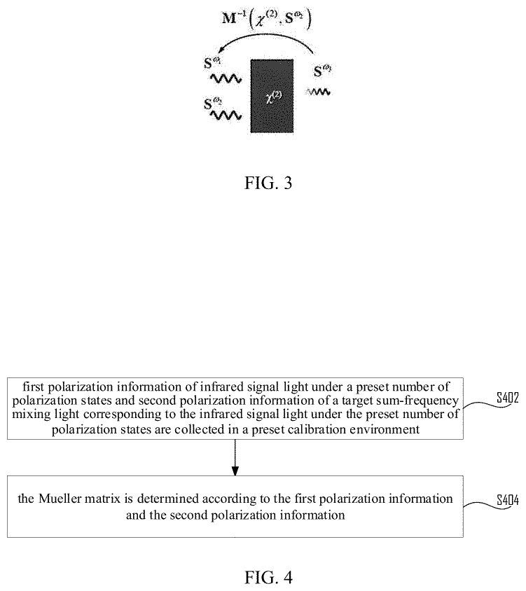

It can be understood that, according to the calculation principle shown in FIG. 3 in combination with the formula (2), the Stokes vector of the sum-frequency mixing light is multiplied by the inverse matrix of the Mueller matrix to obtain the Stokes vector of the infrared signal light.

In the embodiment, the terminal calculates the Stokes vector of the infrared signal light through the processor according to the Stokes vector of the sum-frequency mixing light and the Mueller matrix, so that the polarization information of the infrared signal light can be obtained indirectly by detecting the sum-frequency mixing light. Because the conventional infrared detector is susceptible to large dark current and noise caused by environmental thermal fluctuations, the visible-light detector has a higher accuracy than the infrared detector, so that the infrared measurement method of the present disclosure is correspondingly more efficient.

In an embodiment, as shown in FIG. 4, the infrared measurement method further includes:

Step 402: first polarization information of infrared signal light under a preset number of polarization states and second polarization information of a target sum-frequency mixing light corresponding to the infrared signal light under the preset number of polarization states are collected in a preset calibration environment.

The target sum-frequency mixing light is sum-frequency mixing light generated by the sum-frequency mixing process of the infrared signal light under the preset number of polarization states and the pump light. The preset calibration environment is a background environment in which there is no interference to the infrared detector or an imaging error after interfering with the infrared detector can be ignored. The preset number is a data volume according to which the Mueller matrix can be calculated according to the infrared signal light under the preset number of polarization states and the sum-frequency mixing light under a corresponding preset number of polarization states. Optionally, the preset number can be 6, 8, 12, 72, 73, 74, and so on.

In the embodiment of the present disclosure, in the preset calibration environment, the infrared signal light passes through a polarization state generator (PSG), and the polarization state generator adjusts the polarization state of the incident infrared signal light. The polarization state generator is an instrument configured to adjust the polarization state of the infrared signal light. Optionally, the polarization state generator may consist of a second Glan-Taylor prism, a rotatable half-wave plate (HWP) and a second rotatable quarter-wave plate.

One calibration process is taken for illustration below. The polarization state generator adjusts the polarization state of the infrared signal light; and then the infrared signal light passing through the polarization state generator can be detected by the infrared detector. The infrared detector transmits the intensity information of the detected infrared signal light projected on different polarization bases to the processor 110. The processor 110 processes the intensity information of the infrared signal light projected on different polarization bases to obtain first polarization information of the infrared signal light. Optionally, any algorithm capable of obtaining the polarization information from the intensity information and any algorithm capable of identifying the polarization information of a to-be-measured target from an intensity image can be applied to the embodiments of the present disclosure, which are not limited in the embodiments of the present disclosure.

A sum-frequency mixing process is performed on the infrared signal light passing through the polarization state generator and the pump light by means of the sum-frequency mixing device 104, and a corresponding target sum-frequency mixing light is generated. The visible-light detector 108 detects the corresponding target sum-frequency mixing light, and transmits the intensity information of the corresponding target sum-frequency mixing light projected on different polarization bases to the processor 110. The processor 110 processes the intensity information of the target sum-frequency mixing light projected on different polarization bases to obtain second polarization information of the target sum-frequency mixing light. Optionally, any algorithm capable of obtaining the polarization information from the intensity information and any algorithm capable of identifying the polarization information of the to-be-measured target from the intensity image can be applied to the embodiments of the present disclosure, which are not limited by the embodiments of the present disclosure. In such a manner, through a preset number of calibrations, the first polarization information of the infrared signal light in a preset number of polarization states, and the second polarization information of the target sum-frequency mixing light corresponding to the infrared signal light in a preset number of polarization states can be obtained.

Step 404: the Mueller matrix is determined according to the first polarization information and the second polarization information.

In the embodiment of the present disclosure, the processor 110 obtains a preset amount of first polarization information and a preset amount of second polarization information, and inputs the preset amount of first polarization information and the preset amount of second polarization information into the following shown formula (3), and obtains the Mueller matrix by a fitting calculation with a least square method.

S^{ω}^{₃}=M(χ⁽²⁾,S^{ω}^{₂})·S^{ω}^{₁}; (3)

where S^{ω}^{₃} is the Stokes vector of the sum-frequency mixing light; χ⁽²⁾ is the second-order nonlinear polarizability; S^{ω}^{₂} is the Stokes vector of the pump light; M(χ⁽²⁾, S^{ω}^{₂}) is the Mueller matrix; S^{ω}^{₁} is the Stokes vector of the infrared signal light.

Specifically, the expression of the Mueller matrix is shown as the following formula (1):

$$M ( {χ}^{( 2 )} , {S}^{{ω}_{2}} ) = [ \begin{matrix}{m}_{11} & {m}_{12} & {m}_{13} & {m}_{14} \\ {m}_{21} & {m}_{22} & {m}_{23} & {m}_{24} \\ {m}_{31} & {m}_{32} & {m}_{33} & {m}_{34} \\ {m}_{41} & {m}_{42} & {m}_{43} & {m}_{44}\end{matrix} ] ; \qquad ( 1 )$$

where M(χ⁽²⁾, S^{ω}^{₂}) is the Mueller matrix; χ⁽²⁾ is the second-order nonlinear polarizability; S^{ω}^{₂} is the Stokes vector of the pump light; mₗₙ(l, n=1˜4) is the element in the l-th row and n-th column of the Mueller matrix.

In the embodiment, in the preset calibration environment, the Mueller matrix is calibrated by using the preset amount of polarization information of the infrared signal light and the polarization information of the sum-frequency mixing light to obtain a determined Mueller matrix. Since the conditions of the preset calibration environment have no or negligible interference to the infrared detector, the obtained Mueller matrix has a high accuracy. Therefore, even in an actual measurement environment with a lot of interference, since the Mueller matrix is fixed and not disturbed by environmental factors, the accuracy of the infrared signal light inversed by the Mueller matrix and the sum-frequency mixing light is accordingly improved.

In an embodiment, the step 404 specifically includes the following step.

The expression of the Mueller matrix is constructed according to the second-order nonlinear polarizability and the polarization information of the pump light; the processor determines the Mueller matrix according to the first polarization information, the second polarization information, the expression and the least square method.

In the embodiment of the present disclosure, the expression of the Mueller matrix is shown as the following formula (1):

$$M ( {χ}^{( 2 )} , {S}^{{ω}_{2}} ) = [ \begin{matrix}{m}_{11} & {m}_{12} & {m}_{13} & {m}_{14} \\ {m}_{21} & {m}_{22} & {m}_{23} & {m}_{24} \\ {m}_{31} & {m}_{32} & {m}_{33} & {m}_{34} \\ {m}_{41} & {m}_{42} & {m}_{43} & {m}_{44}\end{matrix} ] ; \qquad ( 1 )$$

where M(χ⁽²⁾, S^{ω}^{₂}) is the Mueller matrix; χ⁽²⁾ is the second-order nonlinear polarizability; S^{ω}^{₂} is the Stokes vector of the pump light; mₗₙ(l, n=1˜4) is the element in the l-th row and n-th column of the Mueller matrix, and is obtained by calculating according to the second-order nonlinear polarizability and the polarization information of the pump light, and the specific expression will be provided later.

In the embodiment of the present disclosure, the processor 110 obtains a preset amount of first polarization information and a preset amount of second polarization information; the processor 110 takes each first polarization information and each corresponding second polarization information as a set of data. There is a preset number of sets of data, and all the data are calculated through the least square method to obtain the Mueller matrix.

In the embodiment, the Mueller matrix is obtained by calculating the discrete sets of data through the least square method. The least square method is a mathematical optimization technique. The Mueller matrix is obtained by calculating with the least square method; the process is simple and the obtained Mueller matrix has a high accuracy. Accordingly, the infrared signal light inversed by using the high-accuracy Mueller matrix is also high.

In an embodiment, the infrared measurement method further includes:
intensity information of the pump light projected on different polarization bases in the to-be-measured scene is detected; polarization information of the pump light is determined according to the intensity information of the pump light projected on different polarization bases; the Mueller matrix is determined according to the polarization information of the pump light and the preset second-order nonlinear polarizability.

The polarization information of the pump light is the Stokes vector of the pump light.

In the embodiment of the present disclosure, a third Glan-Taylor prism is arranged on the optical path of the pump light; and the polarization state of the pump light passing through the third Glan-Taylor prism is adjusted. The intensity information of the pump light with the adjusted polarization state which is projected on different polarization bases is detected. The visible-light detector 108 transmits the intensity information of the pump light projected on different polarization bases to the processor 110. The processor 110 processes the intensity information of the pump light projected on different polarization bases to obtain the Stokes vector of the pump light. Optionally, any algorithm capable of obtaining the polarization information from the intensity information and any algorithm capable of identifying the polarization information of the to-be-measured target from the intensity image can be applied to the embodiments of the present disclosure, which are not limited in the embodiments of the present disclosure. The processor 110 constructs the Mueller matrix according to the Stokes vector of the pump light and the preset second-order nonlinear polarizability.

Specifically, the expression of the Mueller matrix is shown as the following formula (1):

$$M ( {χ}^{( 2 )} , {S}^{{ω}_{2}} ) = [ \begin{matrix}{m}_{11} & {m}_{12} & {m}_{13} & {m}_{14} \\ {m}_{21} & {m}_{22} & {m}_{23} & {m}_{24} \\ {m}_{31} & {m}_{32} & {m}_{33} & {m}_{34} \\ {m}_{41} & {m}_{42} & {m}_{43} & {m}_{44}\end{matrix} ] ; \qquad ( 1 )$$

where M(χ⁽²⁾, S^{ω}^{₂}) is the Mueller matrix; χ⁽²⁾ is the second-order nonlinear polarizability; S^{ω}^{₂} is the Stokes vector of the pump light; mₗₙ(l, n=1˜4) is the element in the l-th row and n-th column of the Mueller matrix, and is obtained by calculating according to the second-order nonlinear polarizability and the polarization information of the pump light, and the specific expression will be provided later.

In the embodiment, the Mueller matrix is obtained by acquiring the Stokes vector of the pump light and the preset second-order nonlinear polarizability, which provides a new technical solution for a method for measuring the Mueller matrix.

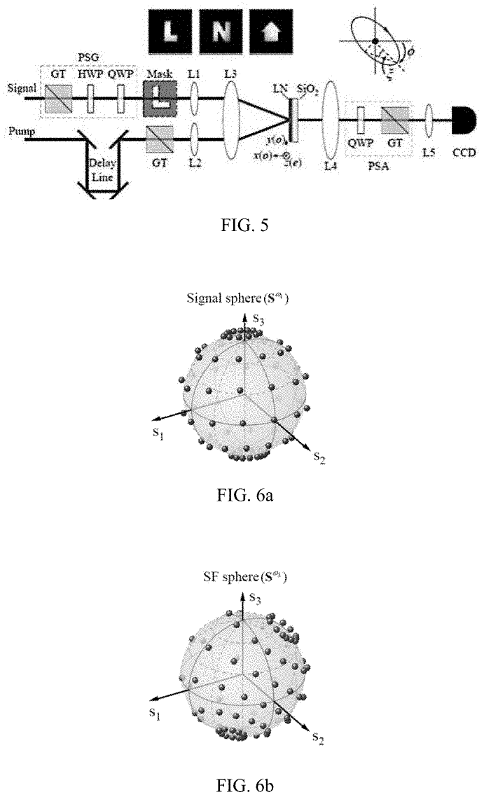

In an embodiment of the present disclosure, an example of determination of an infrared measurement method based on the Mueller matrix through the calibration is provided. Specifically, as shown in FIG. 5, a structure diagram of an infrared measurement device is established; a light source comprises a Kerr lens mode-locked Ti sapphire laser oscillator (Maitai, with a pulse width 230 fs and a repetition refrequency 80 MHz) and a beam splitter. The sum-frequency mixing device is an x-cut lithium niobate thin film on a silicon dioxide substrate with a thickness of 500 μm; and the lithium niobate thin film has a thickness of 200 nm. The visible-light detector uses a charge-coupled element (CCD).

The Kerr lens mode-locked Ti Sapphire generates a near-infrared laser pulse with a wavelength of 808 nm, and a beam splitter is adopted to split the laser pulse into two beams of light, namely the infrared signal light and pump light.

One delay line consisting of a linear motorized translation stage is arranged on the optical path of the pump light to compensate for an optical path difference between the pump light and the infrared signal light, to precisely control the pulse synchronization. By adjusting the delay line, the pump light and the infrared signal light overlap as much as possible in time.

A third Glan-Taylor prism is arranged on the optical path of the pump light, and the polarization state of the pump light passing through the third Glan-Taylor prism is adjusted.

The infrared signal light is incident on the optical path of a fundamental frequency signal, and a polarization state modulation system is arranged on the optical path of the infrared signal light, then the polarization state of the infrared signal light passing through the polarization state modulation system is adjusted. The polarization state modulation system includes one second Glan-Taylor prism, one rotatable half-wave plate and one second rotatable quarter-wave plate.

The infrared signal light and pump light are then condensed and imaged onto the lithium niobate thin film through the lens group, to form a condensed imaging spot with a diameter of 196 μm. The lens group includes a lens L1, a lens L2 and a lens L3. Focal lengths of the lenses L1 and L2 are 500 mm; and the focal length of the lens L3 is 100 mm.

On the surface of the lithium niobate thin film, the sum-frequency mixing process is performed on the pump light and the infrared signal light to generate sum-frequency mixing light. The intensities of the pump light and the infrared signal light are respectively about 65 MW/cm² and 65 MW/cm². The polarization direction of the pump light is along an ordinary (o-) axis of the lithium niobate thin film. The generated sum-frequency mixing light has a wavelength of 404 nm and is collected in a forward direction by a lens L5 with a focal length of 75 mm. A short-pass filter is arranged on the optical path of the sum-frequency mixing light; and the short-pass filter blocks redundant near-infrared laser pulses of 808 nm. The sum-frequency mixing light is incident to the polarization state analyzer 106, and the polarization state analyzer 106 outputs the sum-frequency mixing light projected on different polarization bases, and then the sum-frequency mixing light projected on different polarization bases is detected by the charge-coupled device (CCD). The polarization state analyzer includes one rotatable first quarter-wave plate and one first Glan-Taylor prism.

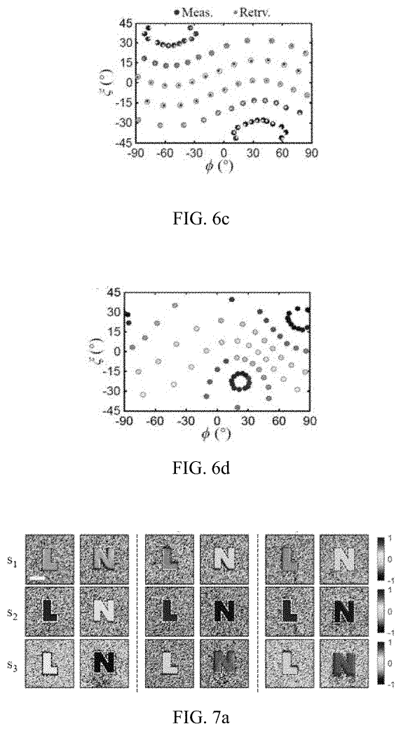

In the preset calibration environment, one calibration process is illustrated as an example, the polarization state modulation system is adjusted to change the polarization state of the infrared signal light. After passing through the polarization state modulation system, the infrared signal light can be detected by the infrared detector. The infrared detector transmits the intensity information of the detected infrared signal light projected on different polarization bases to the processor 110. The processor 110 processes the intensity information of the infrared signal light projected on different polarization bases to obtain the first polarization information of the infrared signal light. Optionally, any algorithm capable of obtaining the polarization information from the intensity information and any algorithm capable of identifying the polarization information of the to-be-measured target from the intensity image can be applied to the embodiment of the present disclosure, which is not limited in the embodiments of the present disclosure. As shown in FIG. 6a, the processor records the obtained first polarization information of the infrared signal light on the first Poincare sphere. The infrared signal light passing through the polarization state modulation system and the pump light have a sum-frequency mixing process on the lithium niobate thin film, and the corresponding target sum-frequency mixing light is generated. The charge coupled element (CCD) detects the corresponding target sum-frequency mixing light, and transmits the intensity information of the corresponding target sum-frequency mixing light projected on different polarization bases to the processor 110. The processor 110 processes the intensity information of the target sum-frequency mixing light projected on different polarization bases to obtain the second polarization information of the target sum-frequency mixing light. Optionally, any algorithm capable of obtaining the polarization information from the intensity information and any algorithm capable of identifying the polarization information of the to-be-measured target from the intensity image can be applied to the embodiments of the present disclosure, which is not limited by the embodiments of the present disclosure. As shown in FIG. 6b, the processor records the obtained second polarization information of the sum-frequency mixing light on the second Poincare sphere.

The processor 110 inputs the first polarization information and the second polarization information into the following formula (3),

S^{ω}^{₃}=M(χ⁽²⁾,S^{ω}^{₂})·S^{ω}^{₁}; (3)

where S^{ω}^{₃} is the Stokes vector of the sum-frequency mixing light; χ⁽²⁾ is the second-order nonlinear polarizability; S^{ω}^{₂} is the Stokes vector of the pump light; M(χ⁽²⁾, S^{ω}^{₂}) is the Mueller matrix; S^{ω}^{₁} is the Stokes vector of the infrared signal light.

The expression of the Mueller matrix is provided as the following formula (1):

$$M ( {χ}^{( 2 )} , {S}^{{ω}_{2}} ) = [ \begin{matrix}{m}_{11} & {m}_{12} & {m}_{13} & {m}_{14} \\ {m}_{21} & {m}_{22} & {m}_{23} & {m}_{24} \\ {m}_{31} & {m}_{32} & {m}_{33} & {m}_{34} \\ {m}_{41} & {m}_{42} & {m}_{43} & {m}_{44}\end{matrix} ] , \qquad ( 1 )$$

where M(χ⁽²⁾, S^{ω}^{₂}) is the Mueller matrix; χ⁽²⁾ is the second-order nonlinear polarizability; S^{ω}^{₂} is the Stokes vector of the pump light; mₗₙ(l, n=1˜4) is the element in the l-th row and n-th column of the Mueller matrix, and is obtained by calculating according to the second-order nonlinear polarizability and the polarization information of the pump light, and the specific expression will be provided later.

In such a manner, through seventy-two calibrations, the processor calculates sixteen elements of the Mueller matrix by using the least square method according to seventy-two sets of first polarization information and corresponding second polarization information, to obtain a calibrated Mueller matrix. The calibrated Mueller matrix is pre-determined as the Mueller matrix in the to-be-measured scene.

In the environment to be measured, without adjusting the polarization state modulation system, the sum-frequency mixing is performed on the infrared signal light scattered, reflected or projected by the to-be-measured target and the and pump light on the lithium niobate thin film, and the sum-frequency mixing light is generated. The sum-frequency mixing light is incident onto the polarization state analyzer 106; and the polarization state analyzer 106 emits the sum-frequency mixing light projected on different polarization bases; and then the emitted sum-frequency mixing light is detected by a charge-coupled device (CCD). When the first quarter-wave plate was rotated from 0° to 180° with a fixed step size of 2°, the CCD detects ninety-one frames of intensity images of the sum-frequency mixing light. The CCD transmits the detected ninety-one frames of intensity images of the sum-frequency mixing light to the processor 110; the processor 110 processes the intensity information of the sum-frequency light projected on different polarization bases to obtain the Stokes vector of the sum-frequency mixing light. Optionally, any algorithm capable of obtaining the polarization information from the intensity information and any algorithm capable of identifying the polarization information of the to-be-measured target from the intensity image can be applied to the embodiments of the present disclosure, which is not limited by the embodiments of the present disclosure.

The processor 110 inputs the Stokes vector of the sum-frequency mixing light into the following formula (2) to obtain the Stokes vector of the infrared signal light,

S^{ω}^{₁}=M⁻¹(χ⁽²⁾,S^{ω}^{₂})·S^{ω}^{₃}, (2)

where S^{ω}^{₁} is the Stokes vector of the infrared signal light; χ⁽²⁾ is the second-order nonlinear polarizability; S^{ω}^{₂} is the Stokes vector of the pump light; M(χ⁽²⁾, S^{ω}^{₂}) is the Mueller matrix; M⁻¹(χ⁽²⁾, S^{ω}^{₂}) is the inverse matrix of the Mueller matrix; S^{ω}^{₁} is the Stokes vector of the infrared signal light.

As shown in FIG. 6c, the Poincare sphere of the infrared signal light is expanded into a two-dimensional graph under the coordinates of a polar angle

$$( ϕ , ϕ = \frac{1}{2} arc tan ( \frac{{s}_{2}}{{s}_{1}} ) )$$

and an angle of ellipsometry

$$( ξ , ξ = \frac{1}{2} arc tan ( \frac{{s}_{3}}{\sqrt{{s}_{1}^{2} + {s}_{2}^{2}}} ) ) .$$

The big dots represent the polarization information of the infrared signal light directly detected; and the small dots in the big circles represent the polarization information of the infrared signal light indirectly detected by the infrared measurement method of the present disclosure. The good overlap between the big dots and the small dots within the big circles indicates the high accuracy of the Mueller matrix calibrated by the infrared measurement method of the present disclosure.

As shown in FIG. 6d, under the coordinates of polar angle ϕ and the angle of ellipsometry ξ, the Poincare sphere of the sum-frequency mixing signal is expanded into a two-dimensional plane graph. The big dots represent the polarization information of the sum-frequency mixing light. Comparing FIG. 6c with FIG. 6d, it can be seen that each of the big dots having different gray levels in FIG. 6d has a corresponding small dot having the same corresponding gray level within a big circle in FIG. 6c, which again shows that the infrared measurement method of the present disclosure has a high accuracy.

The processor 110 synthesizes a polarization image of the to-be-measured target in the to-be-measured scene according to the Stokes vector of the infrared signal light. From the polarized image, the terminal can obtain the detection information of the to-be-measured target in the to-be-measured scene. The detection information of the to-be-measured target in the to-be-measured scene includes a geometric structure, an internal birefringence, an internal stress, a roughness and texture of the surface of the to-be-measured target in the to-be-measured scene.

In the above-mentioned infrared measurement method for determining the Mueller matrix by the calibration mode, the polarization information of the sum-frequency mixing light is acquired by detecting the intensity information of the sum-frequency mixing light projected on different polarization bases, and then the polarization information of the infrared signal light is inversed from the polarization information of the sum-frequency mixing light, so that the polarization information of the infrared signal light can be obtained indirectly. Since the visible-light detector for detecting the sum-frequency mixing light has a higher accuracy than the infrared detector, and the infrared measurement method in the present disclosure is polarization measurement, the sensitivity is higher than that of the intensity measurement. Therefore, under the same background environment, compared to the conventional infrared measurement technology, the information of the sum-frequency mixing light measured by the present disclosure is more accurate, and the inversed infrared polarization information is correspondingly more accurate, thereby improving the accuracies of detection and identification of the measured target.

In an embodiment, an example of an infrared measurement method for determining a Mueller matrix by calibration is provided, which includes:
a mask is arranged on an optical path of the infrared signal light, and the mask is the measured target in the embodiment of the present disclosure; after passing through the polarization state modulation system and the mask, the infrared signal light carries spatial information and polarization information of the mask; optionally, the mask can be an L, N-shaped mask, or a house-shaped mask with a non-uniform birefringence distribution structure.

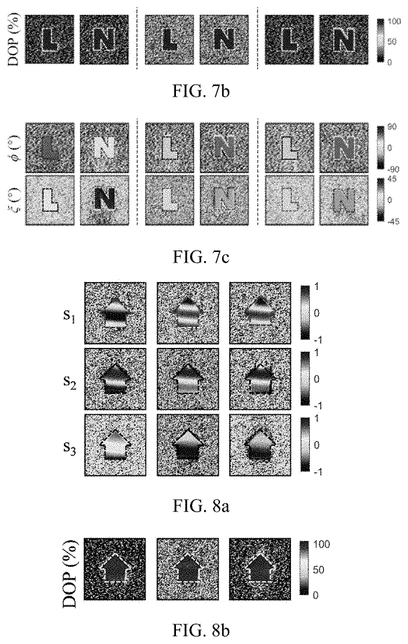

In an embodiment, an L-shaped mask is arranged on the optical path of the infrared signal light. As shown in FIGS. 7a to 7c, s₁ denotes an intensity difference between linear polarization components at 0° and 90°; s₂ denotes an intensity difference between the linear polarization components at −45° and +45°; s₃ denotes an intensity difference between a right-handed circular polarization component and a left-handed circular polarization component; DOP represents a degree of polarization

$$( DOP = \frac{\sqrt{{s}_{1}^{2} + {s}_{2}^{2} + {s}_{3}^{2}}}{{s}_{0}} ) ;$$

ϕ denotes a polar angle

$$( ϕ = \frac{1}{2} arc tan ( \frac{{s}_{2}}{{s}_{1}} ) ) ;$$

and ξ denotes an angle of ellipsometry

$$( ξ = \frac{1}{2} arc tan ( \frac{{s}_{3}}{\sqrt{{s}_{1}^{2} + {s}_{2}^{2}}} ) ) .$$

The first column shows the polarization imaging diagrams of the sum-frequency mixing light; the second column shows the polarization imaging diagrams of the infrared signal light obtained by calculating according to formula (2); and the third column shows the polarization imaging diagrams of the infrared signal light measured directly. Each color band in the polarization images represents an area with the same polarization information.

The Stokes vectors are uniformly distributed in the letter area of the L-shaped mask; outside the letter area of the L-shaped mask, that is, the opaque part of the mask, since no reliable sum-frequency mixing light is detected, the background noise is larger. The polarization imaging in the conventional technology needs to select polarization parameters according to the use situation; and different polarization parameter sets are often used in different situations. The imaging by the infrared measurement method in the present disclosure is shown in FIG. 7a, no matter whether the Stokes parameter is s₁, s₂ or s₃, the second and third columns can still show highly similar polarization images, which indicates that the imaging by the infrared measurement method in the present disclosure can well implement the infrared polarization inversion. The degree of polarization can be directly utilized to determine whether the light is fully polarized light. Since both the infrared signal light and the pump light are fully polarized light, the measured polarization degrees of the sum-frequency mixing light and the infrared signal light are both about 100%, as shown in FIG. 7b, the grayscale corresponding to the degree of polarization of the L-shaped areas in the second column and the third column is approximately the same as the grayscale corresponding to the degree of polarization of 100%, so the imaging result of the infrared measurement method in the present disclosure is as expected. FIG. 7c further draws the polarization image of the polar angle and the angle of ellipsometry, which intuitively presents geometric characteristics of the polarization ellipse. The second column and the third column show a good consistency, that is to say, the polarization information of the infrared signal light indirectly measured by the infrared measurement method in the present disclosure is in good consistency with the polarization information of the infrared signal light measured directly.

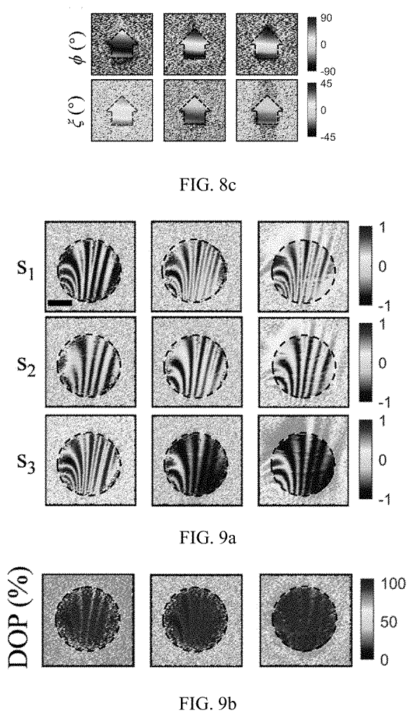

In an embodiment, a house-shaped mask is arranged on the optical path of the infrared signal light; and the house-shaped mask is a non-uniform birefringence distribution structure. As shown in FIGS. 8a to 8c, s₁ denotes an intensity difference between linear polarization components at 0° and 90°; s₂ denotes an intensity difference between the linear polarization components at −45° and +45°; s₃ denotes an intensity difference between a right-handed circular polarization component and a left-handed circular polarization component; DOP represents a degree of polarization

$$( DOP = \frac{\sqrt{{s}_{1}^{2} + {s}_{2}^{2} + {s}_{3}^{2}}}{{s}_{0}} ) ;$$

ϕ denotes a polar angle

$$( ϕ = \frac{1}{2} arc tan ( \frac{{s}_{2}}{{s}_{1}} ) ) ;$$

and ξ denotes an angle of ellipsometry

$$( ξ = \frac{1}{2} arc tan ( \frac{{s}_{3}}{\sqrt{{s}_{1}^{2} + {s}_{2}^{2}}} ) ) .$$

The first column shows the polarization imaging diagrams of the sum-frequency mixing light; the second column shows the polarization imaging diagrams of the infrared signal light obtained by calculating according to the formula (2); and the third column shows the polarization imaging diagrams of the infrared signal light measured directly. Each color band in the polarization images represents an area with the same polarization information.

Referring to FIG. 8a, FIG. 8b and FIG. 8c, the three columns show profiles of changes in the spatial birefringence of the mask. The polarization imaging diagrams of the infrared signal light obtained by the calculation in the second column well reproduce the polarization imaging diagrams of the infrared signal light directly measured in the third column, which proves that the infrared measurement method in the present disclosure has high accuracy and fidelity when applied to the imaging.

In the above-mentioned infrared measurement method for determining the Mueller matrix through the calibration mode, a mask is added as the measured target to obtain the polarization image; by comparing the infrared polarization image obtained indirectly by the method in the present disclosure to the infrared polarization image obtained by a direct measurement, there is a good consistency, which shows that the infrared measurement method in the present disclosure has high accuracy and high fidelity when applied to the imaging.

In an embodiment, an example of an infrared measurement method for determining a Mueller matrix through a calibration mode is provided, the method further includes:
a plastic ruler is arranged on the optical path of the infrared signal light; and the plastic ruler is the measured target in the embodiment of the present disclosure; after passing through the polarization state modulation system and the plastic ruler, the infrared signal light carries polarization information of the plastic ruler.

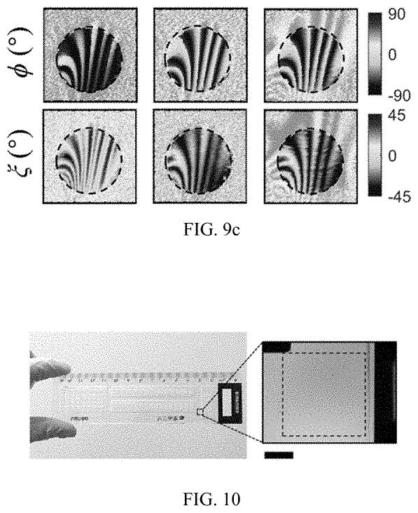

As shown in FIGS. 9a to 9c, s₁ denotes an intensity difference between linear polarization components at 0° and 90°; s₂ denotes an intensity difference between the linear polarization components at −45° and +45°; s₃ denotes an intensity difference between a right-handed circular polarization component and a left-handed circular polarization component; DOP represents a degree of polarization

$$( DOP = \frac{\sqrt{{s}_{1}^{2} + {s}_{2}^{2} + {s}_{3}^{2}}}{{s}_{0}} ) ;$$

ϕ denotes a polar angle

$$( ϕ = \frac{1}{2} arc tan ( \frac{{s}_{2}}{{s}_{1}} ) ) ;$$

and ξ denotes an angle of ellipsometry

$$( ξ = \frac{1}{2} arc tan ( \frac{{s}_{3}}{\sqrt{{s}_{1}^{2} + {s}_{2}^{2}}} ) ) .$$

The first column shows the polarization imaging diagrams of the sum-frequency mixing light; the second column shows the polarization imaging diagrams of the infrared signal light obtained by calculating according to the formula (2); and the third column shows the polarization imaging diagrams of the infrared signal light measured directly. Each color band in the polarization images represents an area with the same polarization information

Referring to FIG. 9a, FIG. 9b and FIG. 9c, the polarization imaging diagrams of the infrared signal light obtained by the calculation in the second column well reproduces the polarization imaging diagrams of the infrared signal light directly measured in the third column, which proves that the infrared measurement method in the present disclosure has the high accuracy and fidelity when applied to the imaging.

Referring to the conventional intensity image in FIG. 10, the inside of the plastic ruler is flat and uniform, but compared to FIGS. 9a to 9c, which shows that the inside of the plastic ruler is unevenly distributed, that is to say, the inside of the plastic ruler has a complex stress corresponding distribution. Therefore, compared to the conventional intensity measurement, the infrared polarization measurement of the present disclosure can obtain more abundant detection information, such as an internal stress, etc.

In one embodiment, the derivation process of formula (2) is as follows:

In order to facilitate the understanding, the deduction in this process is performed for the x-cut lithium niobate thin film based on the sum-frequency mixing device 104. During the sum-frequency mixing generation, the second-order nonlinear polarization intensity P⁽²⁾(ω₃) generated by the lithium niobate thin film satisfies the following formula (4):

Pᵢ⁽²⁾(ω₃)=Σ_{j,k}ε₀χᵢⱼₖ⁽²⁾Eⱼ^{ω}^{₁}Eₖ^{ω}^{₂}; (4)

where the lower indexes i,j and k are unit vectors in directions of the x-axis, y-axis and z-axis in the Cartesian coordinate system, respectively; and the upper indexes ω₁, ω₂ and ω₃ respectively denote the infrared signal light, the pump light and the sum-frequency mixing light. Pᵢ⁽²⁾(ω₃) is the component of the second-order nonlinear polarization intensity P⁽²⁾(ω₃) in the i-direction, which determines the generation of the i-polarization component of the sum-frequency mixing light; ε₀ denotes the dielectric constant in the vacuum, which equal to 8.85×10⁻¹² F/m; χᵢⱼₖ⁽²⁾ denotes the second-order nonlinear polarizability; Eⱼ^{ω}^{₁} denotes the electric field component of the infrared signal light in the j-direction; Eₖ^{ω}^{₂} is the electric field component of the pump light in the k-direction.

The formula (4) can be further written in the form of a matrix, as shown in the following formula (5):

$$[ \begin{matrix}{P}_{x}^{( 2 )} ( {ω}_{3} ) \\ {P}_{y}^{( 2 )} ( {ω}_{3} ) \\ {P}_{z}^{( 2 )} ( {ω}_{3} )\end{matrix} ] = {ε}_{0} [ \begin{matrix}{χ}_{xxx}^{( 2 )} & {χ}_{xyy}^{( 2 )} & {χ}_{xzz}^{( 2 )} & {χ}_{xyz}^{( 2 )} & {χ}_{xzx}^{( 2 )} & {χ}_{xxy}^{( 2 )} \\ {χ}_{yxx}^{( 2 )} & {χ}_{yyy}^{( 2 )} & {χ}_{yzz}^{( 2 )} & {χ}_{yyz}^{( 2 )} & {χ}_{yzx}^{( 2 )} & {χ}_{yxy}^{( 2 )} \\ {χ}_{zxx}^{( 2 )} & {χ}_{zyy}^{( 2 )} & {χ}_{zzz}^{( 2 )} & {χ}_{zyz}^{( 2 )} & {χ}_{zzx}^{( 2 )} & {χ}_{zxy}^{( 2 )}\end{matrix} ] [ \begin{matrix}{E}_{x}^{{ω}_{1}} {E}_{x}^{{ω}_{2}} \\ {E}_{y}^{{ω}_{1}} {E}_{y}^{{ω}_{2}} \\ {E}_{z}^{{ω}_{1}} {E}_{z}^{{ω}_{2}} \\ {E}_{y}^{{ω}_{1}} {E}_{z}^{{ω}_{2}} + {E}_{z}^{{ω}_{1}} {E}_{y}^{{ω}_{2}} \\ {E}_{z}^{{ω}_{1}} {E}_{x}^{{ω}_{2}} + {E}_{x}^{{ω}_{1}} {E}_{z}^{{ω}_{2}} \\ {E}_{x}^{{ω}_{1}} {E}_{y}^{{ω}_{2}} + {E}_{y}^{{ω}_{1}} {E}_{x}^{{ω}_{2}}\end{matrix} ] ; \qquad ( 5 )$$

where x, y, z are respectively coordinate components in the Cartesian coordinate system; χ_{zxx}⁽²⁾, χ_{zyy}⁽²⁾, χ_{zzz}⁽²⁾, χ_{zyz}⁽²⁾, χ_{zzx}⁽²⁾, χ_{zxy}⁽²⁾, χ_{yxx}⁽²⁾, χ_{yyy}⁽²⁾, χ_{yzz}⁽²⁾, χ_{yyz}⁽²⁾, χ_{yzx}⁽²⁾, χ_{yxy}⁽²⁾, χₓₓₓ⁽²⁾, χ_{xyy}⁽²⁾, χ_{xzz}⁽²⁾ χ_{xyz}⁽²⁾, χ_{xzx}⁽²⁾, χ_{xxy}⁽²⁾ are eighteen independent second-order nonlinear polarization tensor elements; Pₓ⁽²⁾(ω₃) is the x-component of the second-order nonlinear polarization intensity, which determines the generation of the x-polarization component of the sum-frequency mixing light; P_{y}⁽²⁾(ω₃) is the y-component of the second-order nonlinear polarization intensity, which determines the generation of the y-polarization component of the sum-frequency mixing light; P_{z}⁽²⁾(ω₃) is the z-component of the second-order nonlinear polarization intensity, which determines the generation of the z-polarization component of the sum-frequency mixing light. Eₓ^{ω}^{₁}, E_{y}^{ω}^{₁}, E_{z}^{ω}^{₁} are respectively the electric field components of the infrared signal light in the x, y, z directions. Eₓ^{ω}^{₂}, E_{y}^{ω}^{₂}, E_{z}^{ω}^{₂} are respectively the electric field components of the pump light in the x, y, and z directions.

The lithium niobate crystal belongs to a 3 m point group. Due to the limitation of symmetry, there are eleven non-zero elements in the nonlinear tensor of the lithium niobate, of which only four elements are independent, i.e., χₑₑₑ⁽²⁾, χₑₒₒ⁽²⁾, χₒₒₒ⁽²⁾ and χₒₒₑ⁽²⁾.

where χ⁽²⁾ is the second-order nonlinear polarizability of the lithium niobate; o represents an ordinary direction in the lithium niobate, which is the y-axis direction; e represents a special direction in the lithium niobate, which is the z-axis direction. eee represents that the fundamental frequency light, along the electric field in the e-axis direction and the electric field effect in the e-axis direction, generates the sum-frequency mixing light vibrating in the e-direction. eoo represents that the fundamental frequency light, along the electric field in the o-axis direction and the electric field effect in the o-axis direction, generates the sum-frequency mixing light vibrating in the e-direction. ooo represents that the fundamental frequency light, along the electric field in the o-axis direction and the electric field effect in the o-axis direction, generates the sum-frequency mixing light vibrating in the o-direction. ooe represents that the fundamental frequency light, along the electric field in the o-axis direction and the electric field effect in the e-axis direction, generates the sum-frequency mixing light vibrating in the o-direction.

Therefore, the second-order nonlinear polarizability χ⁽²⁾ of the lithium niobate can be expressed as the following form:

$${χ}^{( 2 )} = [ \begin{matrix}0 & 0 & 0 & 0 & {χ}_{ooe}^{( 2 )} & - {χ}_{ooo}^{( 2 )} \\ - {χ}_{ooo}^{( 2 )} & {χ}_{ooo}^{( 2 )} & 0 & {χ}_{ooe}^{( 2 )} & 0 & 0 \\ {χ}_{eoo}^{( 2 )} & {χ}_{eoo}^{( 2 )} & {χ}_{eee}^{( 2 )} & 0 & 0 & 0\end{matrix} ] . \qquad ( 6 )$$

The tangential direction of the lithium niobate thin film is the x-tangent, and the thickness direction of the lithium niobate thin film is the x-direction. When the infrared signal light and the pump light are incident onto the surface of the lithium niobate thin film and transmit in the x-direction, yz is the electric field vibration plane of the light, and the electric field vibration plane only has fundamental frequency polarization components in the y-direction and z-direction, while has the fundamental frequency polarization components Eₓ^{ω}^{₁} and Eₓ^{ω}^{₂} in the x-direction which are equal to zero; combined with the formula (6), the formula (5) is transformed as:

$$[ \begin{matrix}{P}_{x}^{( 2 )} ( {ω}_{3} ) \\ {P}_{y}^{( 2 )} ( {ω}_{3} ) \\ {P}_{z}^{( 2 )} ( {ω}_{3} )\end{matrix} ] = {ε}_{0} [ \begin{matrix}0 & 0 & 0 & 0 & {χ}_{ooe}^{( 2 )} & - {χ}_{ooo}^{( 2 )} \\ - {χ}_{ooo}^{( 2 )} & {χ}_{ooo}^{( 2 )} & 0 & {χ}_{ooe}^{( 2 )} & 0 & 0 \\ {χ}_{eoo}^{( 2 )} & {χ}_{eoo}^{( 2 )} & {χ}_{eee}^{( 2 )} & 0 & 0 & 0\end{matrix} ] \cdot [ \begin{matrix}{E}_{y}^{{ω}_{1}} {E}_{y}^{{ω}_{2}} \\ {E}_{z}^{{ω}_{1}} {E}_{z}^{{ω}_{2}} \\ {E}_{y}^{{ω}_{1}} {E}_{z}^{{ω}_{2}} + {E}_{z}^{{ω}_{1}} {E}_{y}^{{ω}_{2}} \\ 0 \\ 0\end{matrix} ] . \qquad ( 7 )$$

Since the second-order nonlinear polarization intensity P⁽²⁾(ω₃) serving as the second harmonic generation source, may radiate the electric field intensity E^{ω}^{₃} of the nonlinear sum-frequency mixing light, the vibration direction of the electric field intensity E^{ω}^{₃} of the sum-frequency mixing light is the same as the direction of the second-order nonlinear polarization intensity P⁽²⁾(ω₃); and the electric field intensity E^{ω}^{₃} of the sum-frequency mixing light is proportional to the second-order nonlinear polarization intensity P⁽²⁾(ω₃). The relationship between the electric field intensity E^{ω}^{₃} of the sum-frequency mixing light and the second-order nonlinear polarization intensity P⁽²⁾(ω₃) can be represented as follows:

$$\{ \begin{matrix}{E}_{y}^{{ω}_{3}} ∝ {P}_{y}^{( 2 )} ( {ω}_{3} ) \\ {E}_{z}^{{ω}_{3}} ∝ {P}_{z}^{( 2 )} ( {ω}_{3} )\end{matrix} ; \qquad ( 8 )$$

where E_{y}^{ω}^{₃} is the electric field component of the sum-frequency mixing light in the y-direction; E_{z}^{ω}^{₃} is the electric field component of the sum-frequency mixing light in the z-direction; P_{y}⁽²⁾(ω₃) is the component of the nonlinear polarization intensity P⁽²⁾(ω₃) in the y-direction; P_{z}⁽²⁾(ω₃) is the component of the nonlinear polarization intensity P⁽²⁾(ω₃) in the z-direction.

According to the relationship between the Stokes vector and the electric field, the Stokes vector is represented as:

$$\{ \begin{matrix}{s}_{0} = 〈 {E}_{y} {E}_{y}^{*} 〉 + 〈 {E}_{z} {E}_{z}^{*} 〉 \\ {s}_{1} = - 〈 {E}_{y} {E}_{y}^{*} 〉 + 〈 {E}_{z} {E}_{z}^{*} 〉 \\ {s}_{2} = - [ 〈 {E}_{z} {E}_{y}^{*} 〉 + 〈 {E}_{z}^{*} {E}_{y} 〉 ] \\ {s}_{3} = j [ 〈 {E}_{z}^{*} {E}_{y} 〉 - 〈 {E}_{z} {E}_{y}^{*} 〉 ]\end{matrix} ; \qquad ( 9 )$$

where so denotes a total light intensity; s₁ denotes an intensity difference between the linear polarization components at 0° and 90°; s₂ denotes an intensity difference between the linear polarization components at +45° and −45°; s₃ denotes an intensity difference between the right-handed circular polarization component and the left-handed circular polarization component. E_{y} denotes the electric field component in the y-direction; and E_{z} denotes the electric field component in the z-direction. j denotes the unit imaginary number; * denotes the conjugate; and < > denotes the time average.

Through the formulas (7), (8) and (9), the following formula (10) is obtained by calculation:

$${s}_{0}^{{ω}_{3}} = 〈 {E}_{y}^{{ω}_{3}} {E}_{y}^{{ω}_{3} *} 〉 + 〈 {E}_{z}^{{ω}_{3}} + {E}_{z}^{{ω}_{3} *} 〉 ∝ 〈 \begin{matrix}[ {χ}_{ooo}^{( 2 )} {E}_{y}^{{ω}_{1}} {E}_{y}^{{ω}_{2}} + {χ}_{ooe}^{( 2 )} {E}_{y}^{{ω}_{1}} {E}_{z}^{{ω}_{2}} + {χ}_{ooe}^{( 2 )} {E}_{z}^{{ω}_{1}} {E}_{y}^{{ω}_{2}} ] \cdot \\ {[ {χ}_{ooo}^{( 2 )} {E}_{y}^{{ω}_{1}} {E}_{y}^{{ω}_{2}} + {χ}_{ooe}^{( 2 )} {E}_{y}^{{ω}_{1}} {E}_{z}^{{ω}_{2}} + {χ}_{ooe}^{( 2 )} {E}_{z}^{{ω}_{1}} {E}_{y}^{{ω}_{2}} ]}^{*}\end{matrix} 〉 + 〈 \begin{matrix}[ {χ}_{eoo}^{( 2 )} {E}_{y}^{{ω}_{1}} {E}_{y}^{{ω}_{2}} + {χ}_{eee}^{( 2 )} {E}_{z}^{{ω}_{1}} {E}_{z}^{{ω}_{2}} ] \cdot \\ {[ {χ}_{eoo}^{( 2 )} {E}_{y}^{{ω}_{1}} {E}_{y}^{{ω}_{2}} + {χ}_{eee}^{( 2 )} {E}_{z}^{{ω}_{1}} {E}_{z}^{{ω}_{2}} ]}^{*}\end{matrix} 〉 ; \qquad ( 10 )$$

where s₀^{ω}^{₃} is the total light intensity of the sum-frequency mixing light; E_{y}^{ω}^{₃} is the electric field component of the sum-frequency mixing light in the y-direction; and E_{z}^{ω}^{₃} is the electric field component of the sum-frequency mixing light in the z-direction.

By using the formula (9), the formula (10) is expanded as a sum of thirteen terms, each term is expressed as follows:

$${〈 {[ {χ}_{ooo}^{( 2 )} {E}_{y}^{{ω}_{1}} {E}_{y}^{{ω}_{1}} ] [ {χ}_{ooo}^{( 2 )} {E}_{y}^{{ω}_{1}} {E}_{y}^{{ω}_{2}} ]}^{*} 〉}_{1} = {χ}_{ooo}^{( 2 )} {χ}_{ooo}^{( 2 ) *} \cdot \frac{{s}_{0}^{{ω}_{1}} - {s}_{1}^{{ω}_{1}}}{2} \frac{{s}_{0}^{{ω}_{2}} - {s}_{1}^{{ω}_{2}}}{2} , \qquad ( 11 )$$

$${〈 {[ {χ}_{ooo}^{( 2 )} {E}_{y}^{{ω}_{1}} {E}_{y}^{{ω}_{2}} ] [ {χ}_{ooe}^{( 2 )} {E}_{y}^{{ω}_{1}} {E}_{z}^{{ω}_{2}} ]}^{*} 〉}_{2} = {χ}_{ooo}^{( 2 )} {χ}_{ooe}^{( 2 ) *} \cdot \frac{{s}_{0}^{{ω}_{1}} - {s}_{1}^{{ω}_{1}}}{2} \frac{- {s}_{2}^{{ω}_{2}} - {js}_{3}^{{ω}_{2}}}{2} , \\ {〈 {[ {χ}_{ooo}^{( 2 )} {E}_{y}^{{ω}_{1}} {E}_{y}^{{ω}_{2}} ] [ {χ}_{ooe}^{( 2 )} {E}_{z}^{{ω}_{1}} {E}_{y}^{{ω}_{2}} ]}^{*} 〉}_{3} = {χ}_{ooo}^{( 2 )} {χ}_{ooe}^{( 2 ) *} \cdot \frac{- {s}_{2}^{{ω}_{1}} - {js}_{3}^{{ω}_{1}}}{2} \frac{{s}_{0}^{{ω}_{2}} - {s}_{1}^{{ω}_{2}}}{2} ,$$

$${〈 {[ {χ}_{ooe}^{( 2 )} {E}_{y}^{{ω}_{1}} {E}_{z}^{{ω}_{2}} ] [ {χ}_{ooo}^{( 2 )} {E}_{y}^{{ω}_{1}} {E}_{y}^{{ω}_{2}} ]}^{*} 〉}_{4} = {χ}_{ooe}^{( 2 )} {χ}_{ooo}^{( 2 ) *} \cdot \frac{{s}_{0}^{{ω}_{1}} - {s}_{1}^{{ω}_{1}}}{2} \frac{{s}_{2}^{{ω}_{2}} + {js}_{3}^{{ω}_{2}}}{2} , \\ {〈 {[ {χ}_{ooe}^{( 2 )} {E}_{y}^{{ω}_{1}} {E}_{z}^{{ω}_{2}} ] [ {χ}_{ooe}^{( 2 )} {E}_{y}^{{ω}_{1}} {E}_{z}^{{ω}_{2}} ]}^{*} 〉}_{5} = {χ}_{ooe}^{( 2 )} {χ}_{ooe}^{( 2 ) *} \cdot \frac{{s}_{0}^{{ω}_{1}} - {s}_{1}^{{ω}_{1}}}{2} \frac{{s}_{0}^{{ω}_{2}} + {s}_{1}^{{ω}_{2}}}{2} ,$$

$${〈 {[ {χ}_{ooe}^{( 2 )} {E}_{y}^{{ω}_{1}} {E}_{z}^{{ω}_{2}} ] [ {χ}_{ooe}^{( 2 )} {E}_{z}^{{ω}_{1}} {E}_{y}^{{ω}_{2}} ]}^{*} 〉}_{6} = {χ}_{ooe}^{( 2 )} {χ}_{ooe}^{( 2 ) *} \cdot \frac{- {s}_{2}^{{ω}_{1}} - {js}_{3}^{{ω}_{1}}}{2} \frac{- {s}_{2}^{{ω}_{2}} + {js}_{3}^{{ω}_{2}}}{2} , \\ {〈 {[ {χ}_{ooe}^{( 2 )} {E}_{z}^{{ω}_{1}} {E}_{y}^{{ω}_{2}} ] [ {χ}_{ooo}^{( 2 )} {E}_{y}^{{ω}_{1}} {E}_{y}^{{ω}_{2}} ]}^{*} 〉}_{7} = {χ}_{ooe}^{( 2 )} {χ}_{ooo}^{( 2 ) *} \cdot \frac{- {s}_{2}^{{ω}_{1}} + {js}_{3}^{{ω}_{1}}}{2} \frac{{s}_{0}^{{ω}_{2}} - {s}_{1}^{{ω}_{2}}}{2} , \\ {〈 {[ {χ}_{ooe}^{( 2 )} {E}_{z}^{{ω}_{1}} {E}_{y}^{{ω}_{2}} ] [ {χ}_{ooe}^{( 2 )} {E}_{y}^{{ω}_{1}} {E}_{z}^{{ω}_{2}} ]}^{*} 〉}_{8} = {χ}_{ooe}^{( 2 )} {χ}_{ooe}^{( 2 ) *} \cdot \frac{- {s}_{2}^{{ω}_{1}} + {js}_{3}^{{ω}_{1}}}{2} \frac{- {s}_{2}^{{ω}_{2}} - {js}_{3}^{{ω}_{2}}}{2} ,$$

$${〈 {[ {χ}_{ooe}^{( 2 )} {E}_{z}^{{ω}_{1}} {E}_{y}^{{ω}_{2}} ] [ {χ}_{ooe}^{( 2 )} {E}_{z}^{{ω}_{1}} {E}_{y}^{{ω}_{2}} ]}^{*} 〉}_{9} = {χ}_{ooe}^{( 2 )} {χ}_{ooe}^{( 2 ) *} \cdot \frac{{s}_{0}^{{ω}_{1} + {s}_{1}^{{ω}_{1}}}}{2} \frac{{s}_{0}^{{ω}_{2}} - {s}_{1}^{{ω}_{2}}}{2} , \\ {〈 {[ {χ}_{eoo}^{( 2 )} {E}_{y}^{{ω}_{1}} {E}_{y}^{{ω}_{2}} ] [ {χ}_{eoo}^{( 2 )} {E}_{y}^{{ω}_{1}} {E}_{y}^{{ω}_{2}} ]}^{*} 〉}_{10} = {χ}_{eoo}^{( 2 )} {χ}_{eoo}^{( 2 ) *} \cdot \frac{{s}_{0}^{{ω}_{1}} - {s}_{1}^{{ω}_{1}}}{2} \frac{{s}_{0}^{{ω}_{2}} - {s}_{1}^{{ω}_{2}}}{2} ,$$

$${〈 {[ {χ}_{eoo}^{( 2 )} {E}_{y}^{{ω}_{1}} {E}_{y}^{{ω}_{2}} ] [ {χ}_{eee}^{( 2 )} {E}_{z}^{{ω}_{1}} {E}_{z}^{{ω}_{2}} ]}^{*} 〉}_{11} = {χ}_{eoo}^{( 2 )} {χ}_{eee}^{( 2 ) *} \cdot \frac{- {s}_{2}^{{ω}_{1}} - {js}_{3}^{{ω}_{1}}}{2} \frac{- {s}_{2}^{{ω}_{2}} - {js}_{3}^{{ω}_{2}}}{2} , \\ {〈 {[ {χ}_{eee}^{( 2 )} {E}_{z}^{{ω}_{1}} {E}_{z}^{{ω}_{2}} ] [ {χ}_{eoo}^{( 2 )} {E}_{y}^{{ω}_{1}} {E}_{y}^{{ω}_{2}} ]}^{*} 〉}_{12} = {χ}_{eee}^{( 2 )} {χ}_{eoo}^{( 2 ) *} \cdot \frac{- {s}_{2}^{{ω}_{1}} + {js}_{3}^{{ω}_{1}}}{2} \frac{- {s}_{2}^{{ω}_{2}} + {js}_{3}^{{ω}_{2}}}{2} ,$$

$${〈 {[ {χ}_{eee}^{( 2 )} {E}_{z}^{{ω}_{1}} {E}_{z}^{{ω}_{2}} ] [ {χ}_{eee}^{( 2 )} {E}_{z}^{{ω}_{1}} {E}_{z}^{{ω}_{2}} ]}^{*} 〉}_{13} = {χ}_{eee}^{( 2 )} {χ}_{eee}^{( 2 ) *} \cdot \frac{{s}_{0}^{{ω}_{1}} + {s}_{1}^{{ω}_{1}}}{2} \frac{{s}_{0}^{{ω}_{2}} + {s}_{1}^{{ω}_{2}}}{2} .$$

Accordingly, the expression of s₀^{ω}^{₃} can be obtained as the following formula (12):

$${s}_{0}^{{ω}_{3}} = {s}_{0}^{{ω}_{1}} \cdot \{ \frac{{s}_{0}^{{ω}_{2}}}{4} [ {\vert {χ}_{eee}^{( 2 )} \vert}^{2} + {\vert {χ}_{eoo}^{( 2 )} \vert}^{2} + {\vert {χ}_{ooo}^{( 2 )} \vert}^{2} + 2 {\vert {χ}_{ooe}^{( 2 )} \vert}^{2} ] + \frac{{s}_{1}^{{ω}_{2}}}{4} [ {\vert {χ}_{eee}^{( 2 )} \vert}^{2} - {\vert {χ}_{eoo}^{( 2 )} \vert}^{2} - {\vert {χ}_{ooo}^{( 2 )} \vert}^{2} ] + \frac{- {s}_{2}^{{ω}_{2}}}{4} [ {χ}_{ooo}^{( 2 )} {χ}_{ooe}^{( 2 ) *} + c . c . ] + \frac{{s}_{3}^{{ω}_{2}}}{4} [ j {χ}_{ooe}^{( 2 )} {χ}_{ooo}^{( 2 ) *} + c . c . ] \} + {s}_{1}^{{ω}_{1}} \cdot \{ \frac{{s}_{0}^{{ω}_{2}}}{4} [ {\vert {χ}_{eee}^{( 2 )} \vert}^{2} - {\vert {χ}_{eoo}^{( 2 )} \vert}^{2} - {\vert {χ}_{ooo}^{( 2 )} \vert}^{2} ] + \frac{{s}_{1}^{{ω}_{2}}}{4} [ {\vert {χ}_{eee}^{( 2 )} \vert}^{2} + {\vert {χ}_{eoo}^{( 2 )} \vert}^{2} + {\vert {χ}_{ooo}^{( 2 )} \vert}^{2} - 2 {\vert {χ}_{ooe}^{( 2 )} \vert}^{2} ] + \frac{{s}_{2}^{{ω}_{2}}}{4} [ {χ}_{ooe}^{( 2 )} {χ}_{ooo}^{( 2 ) *} + c . c . ] + \frac{{s}_{3}^{{ω}_{2}}}{4} [ j {χ}_{ooo}^{( 2 )} {χ}_{ooe}^{( 2 ) *} + c . c . ] \} + {s}_{2}^{{ω}_{3}} \cdot \{ \frac{- {s}_{0}^{{ω}_{2}}}{4} [ {χ}_{ooo}^{( 2 )} {χ}_{ooe}^{( 2 ) *} + c . c . ] + \frac{{s}_{1}^{{ω}_{2}}}{4} [ {χ}_{ooe}^{( 2 )} {χ}_{ooo}^{( 2 )} + c . c . ] + \frac{{s}_{2}^{{ω}_{2}}}{4} [ ( {χ}_{eoo}^{( 2 )} {χ}_{eee}^{( 2 ) *} + c . c . ) + 2 {\vert {χ}_{ooe}^{( 2 )} \vert}^{2} ] + \frac{{s}_{3}^{{ω}_{2}}}{4} [ j {χ}_{eoo}^{( 2 )} {χ}_{eee}^{( 2 ) *} + c . c . ] \} + {s}_{3}^{{ω}_{1}} \cdot \{ \frac{{s}_{0}^{{ω}_{2}}}{4} [ j {χ}_{ooe}^{( 2 )} {χ}_{ooo}^{( 2 ) *} + c . c . ] + \frac{{s}_{1}^{{ω}_{2}}}{4} [ j {χ}_{ooo}^{( 2 )} {χ}_{ooe}^{( 2 ) *} + c . c . ] + \frac{{s}_{2}^{{ω}_{2}}}{4} [ j {χ}_{eoo}^{( 2 )} {χ}_{eee}^{( 2 ) *} + c . c . ] + \frac{{s}_{3}^{{ω}_{2}}}{4} [ - ( {χ}_{eoo}^{( 2 )} {χ}_{eee}^{( 2 ) *} + c . c . ) + 2 {\vert {χ}_{ooe}^{( 2 )} \vert}^{2} ] \} . \qquad ( 12 )$$

Based on the similar deduction process, other expressions of the Stokes vector can be deduced, which will not be repeated here.

All expressions of the Stokes vector are arranged as the following formula (13):

$$\{ \begin{matrix}{s}_{0}^{{ω}_{3}} = {s}_{0}^{{ω}_{1}} {m}_{11} + {s}_{1}^{{ω}_{1}} {m}_{12} + {s}_{2}^{{ω}_{1}} {m}_{13} + {s}_{3}^{{ω}_{1}} {m}_{14} \\ {s}_{1}^{{ω}_{3}} = {s}_{0}^{{ω}_{1}} {m}_{21} + {s}_{1}^{{ω}_{1}} {m}_{22} + {s}_{2}^{{ω}_{1}} {m}_{23} + {s}_{3}^{{ω}_{1}} {m}_{24} \\ {s}_{2}^{{ω}_{3}} = {s}_{0}^{{ω}_{1}} {m}_{31} + {s}_{1}^{{ω}_{1}} {m}_{32} + {s}_{2}^{{ω}_{1}} {m}_{33} + {s}_{3}^{{ω}_{1}} {m}_{34} \\ {s}_{3}^{{ω}_{3}} = {s}_{0}^{{ω}_{1}} {m}_{41} + {s}_{1}^{{ω}_{1}} {m}_{42} + {s}_{2}^{{ω}_{1}} {m}_{43} + {s}_{3}^{{ω}_{1}} {m}_{44}\end{matrix} ; \qquad ( 13 )$$

where mₗₙ(l, n=1˜4) is an element in the l-th row and n-th column of the Mueller matrix, and is obtained by calculation from the second-order linear polarizability and the polarization information of the pump light, and the specific expression can be obtained from the above deduction process in the embodiment of the present disclosure.

The formula (13) can be arranged in the following form:

S^{ω}^{₃}=M(χ⁽²⁾,S^{ω}^{₂})·S^{ω}^{₁}; (3)

where S^{ω}^{₃} is the Stokes vector of the sum-frequency mixing light; χ⁽²⁾ is the second-order nonlinear polarizability; S^{ω}^{₂} is the Stokes vector of the pump light; M(χ⁽²⁾, S^{ω}^{₂}) is the Mueller matrix; S^{ω}^{₁} is the Stokes vector of the infrared signal light.

The formula (3) is further arranged as the formula (2):

S^{ω}^{₁}=M⁻¹(χ⁽²⁾,S^{ω}^{₂})·S^{ω}^{₃}, (2)

where M⁻¹(χ⁽²⁾, S^{ω}^{₂}) is the inverse matrix of the Mueller matrix.

In the embodiment, the formula (3) is obtained by the deductions of formula (4) to formula (13), and the formula (2) is extended from the formula (3). The formula (2) provides the processor with the basis for calculating the Stokes vector of the infrared signal light according to the Stokes vector of the sum-frequency mixing light and the Mueller matrix, so that in the present disclosure the polarization information of the sum-frequency mixing light can be indirectly acquired by detecting the sum-frequency mixing light. Since the detection accuracy of the sum-frequency mixing light is higher than that of the infrared signal light, the polarization information of the infrared signal light with the higher accuracy can be obtained by inverting the polarization information of the sum-frequency mixing light. The detection of the to-be-detected target through the polarization information of the infrared signal light can effectively improve the detection accuracy of the detected target.

It should be appreciated that, although the steps in the flowcharts involved in the above embodiments are sequentially displayed according to the arrows, these steps are not definitely executed in the order indicated by the arrows. Unless explicitly stated herein, the execution of these steps is not strictly limited to the order, and these steps may be performed in other orders. Moreover, at least a part of the steps in the flowcharts involved in the above embodiments may include multiple steps or multiple stages, and these steps or stages are not definitely performed and completed at the same time, but may be performed at different moments. The execution order of these steps or stages is not definitely sequential, but may be performed in turns or alternately with other steps or at least a part of the steps or stages in other steps.

Based on the same inventive concept, the present disclosure in an embodiment also provides an infrared measurement apparatus for implementing the above-mentioned infrared measurement method. The implementation solution for solving the problem provided by the apparatus is similar to the implementation solution described in the above method, as for the specific limitations in one or more embodiments of the infrared measurement apparatus provided below, reference can be made to the above limitations on the infrared measurement method, which is not repeated here.

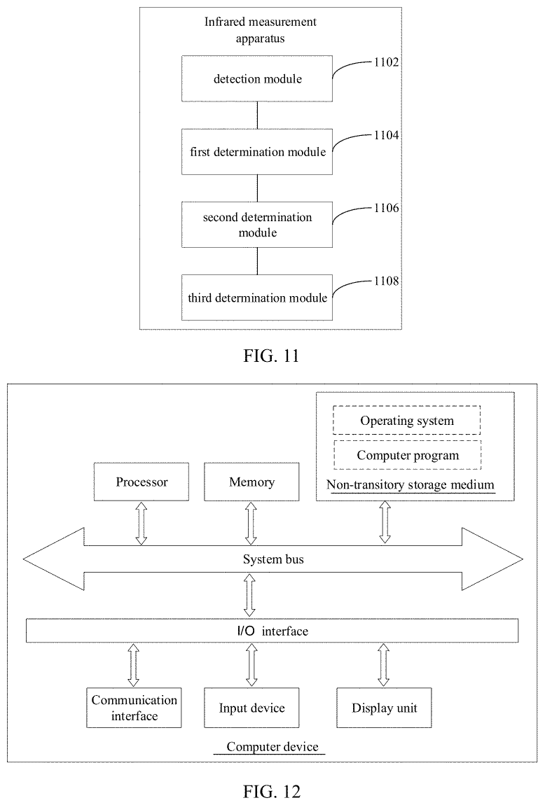

In an embodiment, as shown in FIG. 11, an infrared measurement apparatus is provided, including: a detection module 1102, a first determination module 1104, a second determination module 1106, and a third determination module 1108.

The detection module 1102 is configured to detect intensity information of the sum-frequency mixing light projected on different polarization bases in the to-be-measured scene; in which the sum-frequency mixing light is generated in a sum-frequency mixing process of the infrared signal light and the pump light.

The first determination module 1104 is configured to determine the polarization information of the sum-frequency mixing light according to the intensity information of the sum-frequency mixing light projected on different polarization bases.

The second determination module 1106 is configured to determine polarization information of the infrared signal light according to the polarization information of the sum-frequency mixing light and the Mueller matrix; in which the Mueller matrix is constructed based on the second-order nonlinear polarizability corresponding to the sum-frequency mixing device and the polarization information of the pump light.

The third determination module 1108 is configured to determine detection information of the to-be-measured target in the to-be-measured scene according to the polarization information of the infrared signal light.

In an embodiment, the second determination module 1106 is specifically configured to:
multiple the Stokes vector of the sum-frequency mixing light by an inverse matrix of the Mueller matrix to obtain a Stokes vector of the infrared signal light.

In an embodiment, the infrared measurement apparatus further includes:
a calibration module, which is configured to collect first polarization information of infrared signal light under a preset number of polarization states and second polarization information of a target sum-frequency mixing light corresponding to the infrared signal light under the preset number of polarization states in a preset calibration environment; in which the target sum-frequency mixing light is sum-frequency mixing light generated in the sum-frequency mixing process of the infrared signal light under the preset number of polarization states and the pump light.
a fourth determination module, which is configured to determine the Mueller matrix according to the first polarization information and the second polarization information.

In an embodiment, the fourth determination module is configured to:
construct the expression of the Mueller matrix according to the second-order nonlinear polarizability and the polarization information of the pump light, and determine the Mueller matrix according to the first polarization information, the second polarization information, the expression and the least square method.

In an embodiment, the infrared measurement apparatus further includes:
a pump light detection module, which is configured to detect intensity information of the pump light projected on different polarization bases in the to-be-measured scene;
a fifth determination module, which is configured to determine polarization information of the pump light according to the intensity information of the pump light projected on different polarization bases;
a sixth determination module, which is configured to determine the Mueller matrix according to the polarization information of the pump light and the preset second-order nonlinear polarizability.

Each module in the above-mentioned infrared measurement apparatus can be implemented in whole or in part by software, hardware and combinations thereof. The above modules can be embedded in or independent of a processor in a computer device in the form of hardware, or stored in a memory of the computer device in the form of software, so that the processor can call and execute the operations corresponding to the above modules.

In an embodiment, a computer device is provided, and the computer device can be a terminal, and its internal structure diagram can be as shown in FIG. 12. The computer device includes a processor, a memory, a communication interface, a display screen, and an input device connected by a system bus. The processor of the computer device is configured to provide computing and control capabilities. The memory of the computer device includes a non-transitory storage medium, an internal memory. The non-transitory storage medium stores an operating system and a computer program. The internal memory provides an environment for the execution of the operating system and the computer program in the non-transitory storage medium. The communication interface of the computer device is used for wired or wireless communication with an external terminal; and the wireless communication can be implemented by WIFI, a mobile cellular network, a Near Field Communication (NFC) or other technologies. The computer program, when executed by the processor, implements an infrared measurement method. The display screen of the computer device can be a liquid crystal display screen or an electronic ink display screen, and the input device of the computer device can be a touch layer covering the display screen, or a button, a trackball or a touchpad arranged on the housing of the computer device, or an external keyboard, trackpad, or mouse, etc.

Those skilled in the art can understand that the structure shown in FIG. 12 is only a block diagram of a partial structure related to the solution of the present disclosure, and does not constitute a limitation on the computer device to which the solution of the present disclosure is applied. A specific computer device may include more or fewer components than that shown in the figures, or combine certain components, or have a different arrangement of components.

In an embodiment, a computer device is further provided, including a processor and a memory for storing a computer program, and the processor implements the steps in the foregoing method embodiments when executing the computer program.

In an embodiment, a computer-readable storage medium is provided, on which a computer program is stored, and when the computer program is executed by a processor, the steps in the foregoing method embodiments are implemented.

In an embodiment, a computer program product is provided, including a computer program, the steps in the foregoing method embodiments are implemented when the computer program is executed by a processor.

It should be noted that the user information (including but not limited to user device information, user personal information, etc.) and data (including but not limited to data for analysis, stored data, displayed data, etc.) involved in the present disclosure are all information and data authorized by the user or fully authorized by the parties.

Those of ordinary skill in the art can understand that all or part of the processes in the methods of the above embodiments can be implemented by instructing relevant hardware through a computer program, and the computer program can be stored in a non-transitory computer-readable storage medium. When the computer program is executed, the processes in the above-mentioned method embodiments can be implemented. Any reference to a memory, a database or other media used in the various embodiments provided in the present disclosure may include at least one of a non-transitory memory and a transitory memory. The non-transitory memory may include Read-Only Memory (ROM), magnetic tape, floppy disk, flash memory, optical memory, high-density embedded non-transitory memory, Resistive Random Access Memory (ReRAM), Magnetoresistive Random Access Memory (MRAM), Ferroelectric Random Access Memory (FRAM), Phase Change Memory (PCM), graphene memory, etc. The transitory memory may include random access memory (RAM) or external cache memory, and the like. By way of illustration and not limitation, the RAM may be in various forms, such as static random access memory (SRAM) or dynamic random access memory (DRAM). The database involved in the various embodiments provided in the present disclosure may include at least one of a relational database and a non-relational database. The non-relational database may include a blockchain-based distributed database, etc., but is not limited thereto. The processors involved in the various embodiments provided in the disclosure may be general-purpose processors, central processing units, graphics processors, digital signal processors, programmable logic devices, data processing logic devices based on quantum computing, etc., and are not limited thereto.

The above-mentioned embodiments are merely several exemplary embodiments of the present disclosure, and the descriptions are more specific and detailed, but they should not be interpreted as limiting the scope of the disclosure. It should be pointed out that those of ordinary skill in the art can make several modifications and improvements without departing from the concept of the present disclosure, and these all fall within the protection scope of the present disclosure. Therefore, the protection scope of the present disclosure should be subject to the appended claims.

What is claimed is:

1. An infrared measurement method, comprising:
detecting intensity information of sum-frequency mixing light projected on different polarization bases in a to-be-measured scene, wherein the sum-frequency mixing light is generated in a sum-frequency mixing process of infrared signal light and pump light;
determining polarization information of the sum-frequency mixing light according to the intensity information of the sum-frequency mixing light projected on the different polarization bases;
determining polarization information of the infrared signal light according to the polarization information of the sum-frequency mixing light and a Mueller matrix, wherein the Mueller matrix is constructed based on a second-order nonlinear polarizability corresponding to a sum-frequency mixing device and the polarization information of the pump light;
determining detection information of a to-be-measured target in the to-be-measured scene according to the polarization information of the infrared signal light.

2. The method according to claim 1, wherein the polarization information of the sum-frequency mixing light is a Stokes vector of the sum-frequency mixing light, and the determining polarization information of the infrared signal light according to the polarization information of the sum-frequency mixing light and the Mueller matrix comprises:
multiplying the Stokes vector of the sum-frequency mixing light by an inverse matrix of the Mueller matrix to obtain a Stokes vector of the infrared signal light.

3. The method according to claim 1, further comprising:
collecting first polarization information of infrared signal light under a preset number of polarization states and second polarization information of a target sum-frequency mixing light corresponding to the infrared signal light under the preset number of polarization states in a preset calibration environment;
determining the Mueller matrix according to the first polarization information and the second polarization information.

4. The method according to claim 3, wherein the determining the Mueller matrix according to the first polarization information and the second polarization information comprises:
constructing an expression of the Mueller matrix according to the second-order nonlinear polarizability and the polarization information of the pump light;
determining the Mueller matrix according to the first polarization information, the second polarization information, the expression, and a least square method.

5. The method according to claim 1, further comprising:
detecting intensity information of the pump light projected on different polarization bases in the to-be-measured scene;
determining polarization information of the pump light according to the intensity information of the pump light projected on the different polarization bases;
determining the Mueller matrix according to the polarization information of the pump light and the preset second-order nonlinear polarizability.

6. An infrared measurement device, comprising:
a light source configured to generate infrared signal light and pump light;
a sum-frequency mixing device configured to perform a sum-frequency mixing process on the infrared signal light and the pump light in a to-be-measured scene to generate sum-frequency mixing light;
a polarization state analyzer configured to acquire the sum-frequency mixing light projected on different polarization bases;
a visible-light detector configured to detect intensity information of the sum-frequency mixing light projected on the different polarization bases;
a processor configured to: determine polarization information of the sum-frequency mixing light according to the intensity information of the sum-frequency mixing light projected on different polarization bases; obtain polarization information of the infrared signal light according to the polarization information of the sum-frequency mixing light and a Mueller matrix, wherein the Mueller matrix is constructed based on a second-order nonlinear polarizability corresponding to the sum-frequency mixing device and polarization information of the pump light; and determine detection information of a to-be-measured target in the to-be-measured scene according to the polarization information of the infrared signal light.

7. An infrared measurement apparatus, comprising:
a detection module, configured to detect intensity information of sum-frequency mixing light projected on different polarization bases in a to-be-measured scene, wherein the sum-frequency mixing light is generated in a sum-frequency mixing process of infrared signal light and pump light;
a first determination module, configured to determine polarization information of the sum-frequency mixing light according to the intensity information of the sum-frequency mixing light projected on the different polarization bases;
a second determination module, configured to determine polarization information of the infrared signal light according to the polarization information of the sum-frequency mixing light and a Mueller matrix, wherein the Mueller matrix is constructed based on a second-order nonlinear polarizability corresponding to a sum-frequency mixing device and polarization information of the pump light;
a third determination module, configured to determine detection information of a to-be-measured target in the to-be-measured scene according to the polarization information of the infrared signal light.

8. A computer device, comprising a processor and a memory for storing a computer program, wherein when executing the computer program, the processor implements the method according to claim 1.

9. A computer-readable storage medium, on which a computer program is stored, wherein when the computer program is executed by a processor, the method of claim 1 is implemented.

10. A computer program product, comprising a computer program, wherein the method of claim 1 is implemented when the computer program is executed by a processor.
